(19) United States
(12) Patent Application Publication
(10) Pub. No.: US 2002/0067351 A1
(43) Pub. Date: Jun. 6, 2002

(54) DEVICE FOR AUTOMATICALLY CONTROLLING IMAGES ON FLAT PANEL DISPLAY AND METHODS THEREFOR

(76) Inventor: YOUNG-CHAN KIM, ANYANG-SI (KR)

Correspondence Address: STAAS & HALSEY LLP, 700 11TH STREET, NW, SUITE 500, WASHINGTON, DC, 20001, US

(21) Appl. No.: 09/236,402

(22) Filed: Jan. 25, 1999

(30) Foreign Application Priority Data
Jan. 24, 1998 (KR) 98-2187

(51) Int. Cl. G09G 5/00

(52) U.S. Cl. 345/204

(57) ABSTRACT

A device for receiving video signals and horizontal and vertical synchronizing signals using a flat panel display device for discriminating modes thereof, displaying the best images by automatically controlling the mode, in case the mode is unsuitable for the flat panel and a method therefor. A micro-controller discriminates modes according to the input horizontal and vertical synchronizing signals, and outputs an OSD (on screen display) control signal and pixel clock control signals according to the discriminated modes. A phase-locked loop controls timing of pixel clocks according to the pixel clock signals control of the micro-controller and outputs the pixel clocks. An analog to digital converter receives video signals, and samples the video signals according to the pixel clocks from the phase-locked loop, converts the video signals into digital video signals, and a video controller receives the digital video signals transmitted from the analog-digital converter and outputs the digital video signals to a panel driver according to the pixel clocks from the phase-locked loop and the OSD control signal from the micro-controller.

### CLAIM OF PRIORITY

This application makes reference to, incorporates the same herein, and claims all benefits accruing under 35 U.S.C. §119 from my application entitled Auto Control Apparatus For The Image On Flat Panel Display and Method Thereof filed with the Korean Industrial Property Office on Jan. 24, 1998 and there duly assigned Serial No. 98-02187 by that Office.

### BACKGROUND OF THE INVENTION

1. Field of the Invention

The present invention relates to a device and method for automatically controlling images on a flat panel display, and more particularly, to a device and method for displaying the best images by automatically controlling a mode, in case the mode is unsuitable for the flat panel.

2. Description of the Related Art

A plasma display panel (abbreviated to PDP hereafter), a liquid crystal display (abbreviated to LCD hereafter) and a light emitting diode display (abbreviated to LED hereafter) belong to the family of flat panel display devices. Among the displays, the LCD, which is generally utilized, is used as a display for a portable terminal as well as for a desktop computer. And the PDP is being developed as a display for television broadcasts.

The flat panel display receives image signals and horizontal and vertical synchronizing signals from a host. The received image signals are synchronized by the flat panel display according to the horizontal and vertical synchronizing signals and displayed thereby. At this time, the image signals generated from the host can have various types of modes according to sorts of video cards equipped in the host. In this case, a preset mode of the flat panel display is stored for the signals by setting various parameters, such as horizontal and vertical positions and sizes according to video modes, to a factory mode.

Accordingly, the flat panel display displays the images employing the parameters nearest to the preset mode in the case that the mode is unsuitable for the flat panel display. This causes a distortion of images because timing of the horizontal and vertical synchronizing signals generating from the host is not suitable for the flat panel display. In order to compensate for the distortion, conventionally, a user has artificially corrected it using a key, which is used to adjust the image distortion and equipped outside the flat panel display.

### SUMMARY OF THE INVENTION

Accordingly, to overcome such drawbacks present in the conventional art, it is therefore an object of the present invention to provide a device for receiving video signals and horizontal and vertical synchronizing signals using a flat panel display device, for discriminating modes thereof, and for displaying the best images by automatically controlling the mode of the video, and in particular, in the case that the mode is unsuitable for the flat panel and a method therefor.

Additional objects and advantages of the invention will be set forth in part in the description which follows and, in part, will be obvious from the description, or may be learned by practice of the invention.

To achieve the above and other advantages and in accordance with the purpose of the present invention, as embodied and broadly described, there is provided a device for automatically controlling images of a flat panel display, the device including a micro-controller for discriminating modes according to input horizontal and vertical synchronizing signals, and for outputting an OSD (on screen display) signal and pixel clock control signals according to the discriminated modes, a phase-locked loop for controlling timing of pixel clocks according to the pixel clock control signals of the micro-controller, an analog to digital converter for receiving video signals, for sampling the video signals according to the pixel clocks from the phase-locked loop, for converting the video signals into digital video signals, and a video controller for receiving the digital video signals transmitted from the analog-digital converter, for outputting the digital video signals to a panel driver according to the pixel clocks from the phase-locked loop and the OSD control signal offered from the micro-controller.

According to another aspect of the present invention, there is also provided a method for automatically controlling images of a flat panel display, the method including the steps of checking whether an input mode is a first preset mode after discriminating a mode of received horizontal and vertical synchronizing signals, driving another preset mode nearest to the input mode in case the input mode is not the first preset mode in the checking step, controlling a horizontal parameter according to the input mode in response to the nearest mode being driven in the driving step, and controlling a vertical parameter when the horizontal parameter is controlled in the controlling step.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols represent the same or similar components, wherein:

FIG. 1 is a block view illustrating a construction of an inner circuit of the flat panel display according to an embodiment of the present invention;

FIG. 2 is a view of a memory map of a video controller illustrated in FIG. 1;

FIGS. 3A through 3E are waveform views of video signals, horizontal and vertical synchronizing signals and a pixel clock output from a PLL illustrated in FIG. 1;

FIG. 4 is a view of a column memory map illustrating a memory status of image data according to the pixel clocks illustrated in FIG. 3;

FIG. 5 is a flow view illustrating a method of automatically controlling images of the flat panel display according to the embodiment of the present invention;

FIG. 6 is a flow view illustrating a sub-routine of a horizontal parameter adjustment method shown in FIG. 5;

FIG. 7 is a flow view illustrating a sub-routine of a horizontal position control method shown in FIG. 6;

FIG. 8 is a flow view illustrating a sub-routine of a vertical parameter adjustment method shown in FIG. 5; and

FIG. 9 is a flow view illustrating a sub-routine of a vertical position control method shown in FIG. 8.

### DESCRIPTION OF THE PREFERRED EMBODIMENT

The present invention will be apparent from the following description in conjunction with the accompanying drawings.

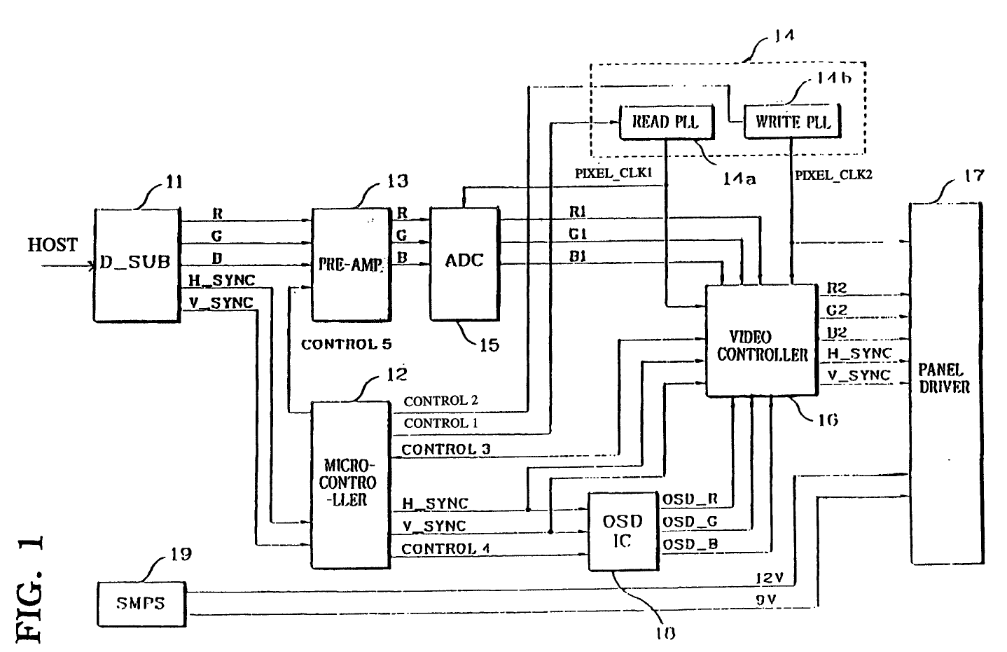

According to an embodiment of the present invention, as shown in FIG. 1, a device for automatically controlling images of a flat panel display includes a micro-controller 12 for discriminating modes according to input horizontal and vertical synchronizing signals (H_SYNC and V_SYNC), and for generating a control signal (CONTROL 4) to generate outputting OSD (on screen display) signals (OSD-R, OSD-G, OSD-B) and pixel clock control (CONTROL 1, CONTROL 2) signals according to the discriminated modes; a phase-locked loop 14 for controlling timing of pixel clocks according to the pixel clock control signals (CONTROL 1, CONTROL 2) of the micro-controller 12; an analog to digital converter (ADC) 15 for receiving video signals (R, G, B), for sampling the video signals (R, G, B) according to the timing of the pixel clock (PIXEL_CLK1) from the phase-locked loop 14, and output therefrom, for converting the video signals into digital video signals; and a video controller 16 for receiving the digital video signals transmitted from the analog-digital converter, for outputting the digital video signals to a panel driver 17 according to the pixel clocks (PIXEL_CLK1, PIXEL_CLK2) from the phase-locked loop 14 and the control signals from the micro-controller 12.

Further, the device for automatically controlling images according to the embodiment of the present invention can be described in detail as follows.

The flat panel display receives the video signals (R, G, B) and the horizontal and vertical synchronizing signals (H_SYNC, V_SYNC) generated from a host and output therefrom, discriminates modes thereof, and controls and displays images according to the modes respectively. A D_SUB (D-shaped connector) 11 within the flat panel display receives the video signals (R, G, B) and the horizontal and vertical synchronizing signals (H_SYNC, V_SYNC) output from the host. The micro-controller 12 receives the horizontal and vertical synchronizing signals (H_SYNC, V_SYNC) transmitted from the D_SUB 11. The micro-controller 12 counts the received horizontal and vertical synchronizing signals (H_SYNC, V_SYNC) using horizontal and vertical register counters (not illustrated) therein.

The horizontal and vertical register counters count the timing of the received horizontal and vertical synchronizing signals (H_SYNC, V_SYNC). The micro-controller 12 discriminates the modes of the video signals (R, G, B) transmitted to the flat panel display according to the counted result. The device for automatically controlling images includes a memory device (not shown) which stores a plurality of predetermined factory mode values (preset modes) and has room for storing user-defined modes. When the mode suitable to the flat panel (not illustrated) is received, the micro-controller 12 drives a preset mode which is set as one of the stored factory modes. On the contrary, when the mode unsuitable to the flat panel (not illustrated) is received, the micro-controller 12 drives another (second) preset mode nearest to the preset mode. When the second preset mode nearest to the preset mode is driven, the horizontal and vertical parameters of the images are controlled according to the driven nearest second preset mode.

The micro-controller 12 outputs first, second, third control signals (CONTROL 1, 2, 3) to control the horizontal and vertical parameters. In addition, the micro-controller 12 outputs the information for controlling the images according to the mode by generating a fourth control signal (CONTROL 4) as an OSD (on screen display) control signal and a fifth control signal (CONTROL 5) as a clamping control signal for determining an amplifying level of the video signals. A preamplifier 13 receives the fifth control signal (CONTROL 5). The preamplifier 13 receives, amplifies, and outputs the video signals (R, G, B) transmitted from the D-SUB 11 according to the fifth control signal (CONTROL 5).

The analog to digital converter (ADC) (15) receives the video signals (R, G, B), which are analog video signals, and converts the analog video signals (R, G, B) into digital video signals (R1, G1, B1) and outputs the digital video signals (R, G, B). The ADC 15 converts the analog video signals (R, G, B) into first data which are the digital video signals (R1, G1, B1) and outputs the first data according to a sampling period of the pixel clock (PIXEL_CLK1) being output from a read PLL (phase-locked-loop) 14a of the PLL 14. The pixel clock (PIXEL_CLK1) is locked in and output according to the first control signal (CONTROL 1). The first control signal (CONTROL 1) is a control signal for controlling the timing of the pixel clock (PIXEL_CLK1) being output from the read PLL 14a. At the same time, the micro-controller 12 generates the second control signal (CONTROL 2) and controls the timing of a pixel clock (PIXEL_CLK2) being output from the write PLL 14b.

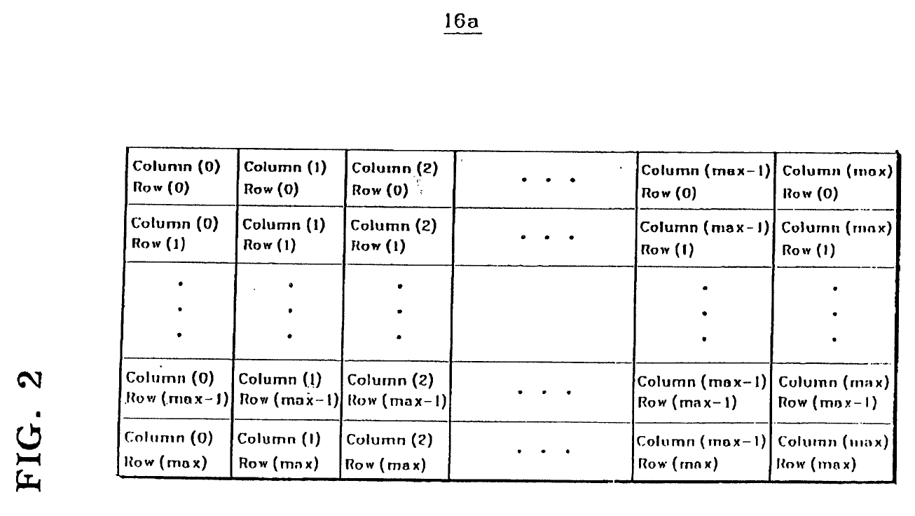

The first data (R1, G1, B1), converted into digital signals and output by the ADC 15, are stored in the video controller 16 by the pixel clock (PIXEL_CLK2) being output from the write PLL 14b of the PLL 14. The video controller 16 stores the first data (R1, G1, B1) in a line memory 16a (shown in FIG. 2), according to the pixel clock (PIXEL_CLK) being output from the read PLL 14a. The line memory 16a, as shown in FIG. 2, is constituted by a matrix having columns (0 to Nth), rows (0 to Nth), and stores the first data (R1, G1, B1) transmitted from the ADC 15 in order.

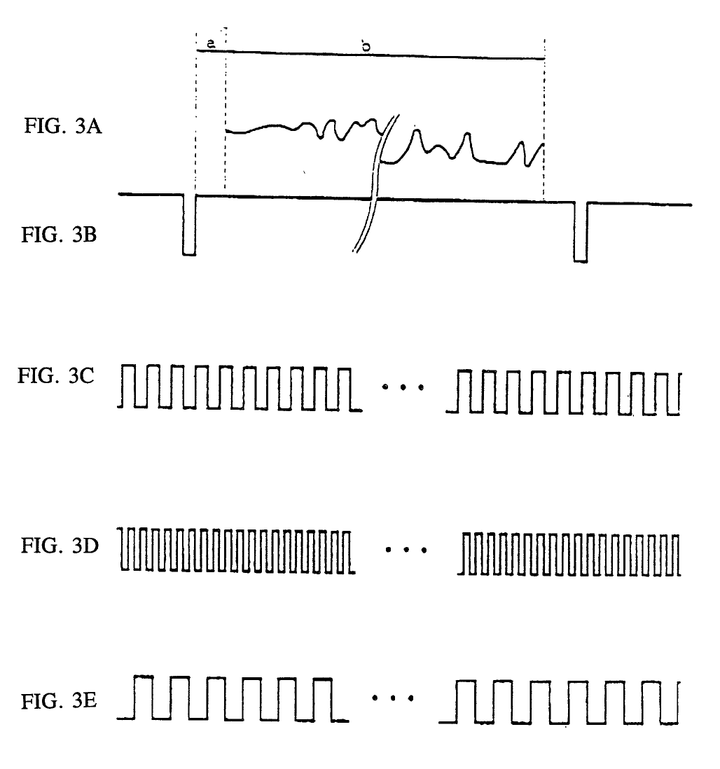

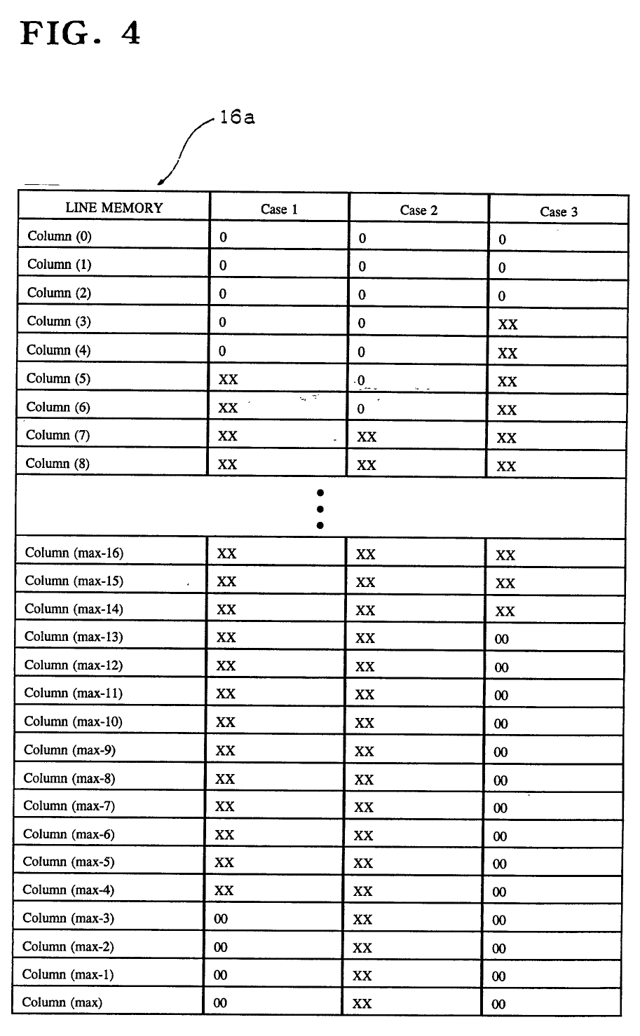

The first data (RI, G1, B1) are data, the sizes of which are adjusted according to the mode discriminated in the micro-controller 12. The sizes of the images of the first data (R1, G1, B1) are adjusted suitably for the modes in the process of being sampled by the ADC 15. That is illustrated more concretely in FIGS. 3A through FIG. 4.

FIG. 3A shows the waveforms which are video signals (R, G, B) transmitted to the flat panel display device. The video signals (R, G, B) are received for a period of the horizontal synchronizing signal (H_SYNC) illustrated in FIG. 3B. The video signals (R, G, B) received for a period of the horizontal synchronizing signal (H_SYNC) are divided into an offset area (a) of the horizontal and vertical synchronizing signals (H_SYNC, V_SYNC), in which the level of the video signals (R, G, B) becomes ‘0’, and an active area (b) of actual video signals (R, G, B). The video signals (R, G, B) of the active area (b) are sampled by the ADC 15 according to the timing of the same pixel clocks as shown in FIGS. 3C through 3E.

Assuming that the video signals (R, G, B) sampled by the waveform shown in FIG. 3D are preset, the waveform shown in FIG. 3C indicates a slower timing than the waveform shown in FIG. 3D, and the waveform shown in FIG. 3E has a pixel clock which has a slower timing than the waveform shown in FIG. 3C. FIG. 4 shows how the first data (R1, G1, B1) sampled by each of the waveforms shown in FIGS. 3C through 3E are stored in the address of the column of the line memory 16a. FIG. 4 shows how the first data (R1, G1, B1) are stored in the addresses of columns of cases (case 1, 2, 3), respectively. Accordingly, the data stored in the addresses of the columns of the line memory 16a are displayed on the basis of the waveform shown in FIG. 3D by repeatedly adding or deleting the sampling pixel clocks at the sampling time.

For example, if the flat panel has a resolution of 1204×768 and the now received mode has a resolution of 800×600, the resolution can be adjusted to (800+a)×(600+b) by repeatedly adding the data for a determined period. In this instance, “a” represents the number of the data being read in a blanking period and “b” represents the number of the data being driven in a blanking period. On the contrary, if the flat panel has the resolution of 800×600 and the now received mode has the resolution of 1204×768, the resolution can be adjusted to (800−a)×(600−b) by repeatedly deleting the data for a determined period.

If the resolution, that is the size of images, is adjusted suitably for the flat panel, the position of the images is adjusted. The video controller 16 transmits the address position of the first data (R1, G1, B1) stored in the line memory 16a to the micro-controller 12. Values of the left, right, top, bottom end registers (not illustrated) are transmitted to the micro-controller 12 according to the positions of the first data (R1, G1, B1) stored in the line memory 16a respectively. The micro-controller 12 generates and outputs the third control signal (control 3) to control the begin and end positions for displaying the first data (R1, G1, B1) to the flat panel according to the values of the transmitted registers, respectively. The micro-controller 12 calculates the begin and end positions for displaying the first data to the flat panel according to the values of the transmitted registers respectively transmitted from the video controller 16 in the storing state of the displaying position of the flat panel.

The video controller 16 receives the third control signal (CONTROL 3) output from the micro-controller 12 and outputs second data (R2, G2, B2), in which the displaying position of the stored first data (R1, G1, B1) has been adjusted. Here, in the third control signal (CONTROL 3) output from the micro-controller 12 are included the control signals for adjusting positions of images as well as colors. The video controller 16 generates the second data (R2, G2, B2). The video controller 16 receives the pixel clock (PIXEL_CLK1) output from the read PLL 14a and outputs the second data (R2, G2, B2) according to the received pixel clock (PIXEL_CLK1).

The second data (R2, G2, B2) are transmitted by the panel driver 17 to the flat panel. The panel driver 17 receives the horizontal and vertical synchronizing signals output through the micro-controller 12 and the video controller 16 and displays the second data (R2, G2, B2) on the flat panel. At this time, the second data (R2, G2, B2) are not at a strong enough level for being displayed on the flat panel. Thus, the panel driver 17 receives driving power (12V, 9V), for amplifying the second data (R2, G2, B2) to a sufficient level, from a switching mode power supply 19. The panel driver 17 adjusts and displays the mode adjusted for the flat panel through amplifying the second data (R2, G2, B2) to the sufficient level and displays the second data on the flat panel.

Further, the OSD IC 18 displays information for image adjustment. In order to display information for image adjustment, the OSD IC 18 receives the fourth control signal (CONTROL 4) and the horizontal and vertical synchronizing signals (H_SYNC, V_SYNC) from the micro-controller 12. Then, the OSD IC 18 stores the fourth control signal (CONTROL 4) according to the timing of the received horizontal and vertical synchronizing signals (H_SYNC, V_SYNC). The stored fourth control signal (CONTROL 4) is converted into OSD data (OSD_R, OSD_G, OSD_B) when a user chooses it. The outputted OSD data (OSD_R, OSD_G, OSD_B) are received by the video controller 16. The video controller 16 updates the first data (R1, G1, B) stored in the storing position of the received OSD data (OSD_R, OSD_G, OSD_B) and transmits the first data to the panel driver 17. The panel driver 17 drives and displays the OSD data (OSD_R, OSD_G, OSD_B) on the flat panel, and displays the now adjusted image information.

The control program of the micro-controller 12 can be considered in detail in conjunction with the accompanying drawings as follows.

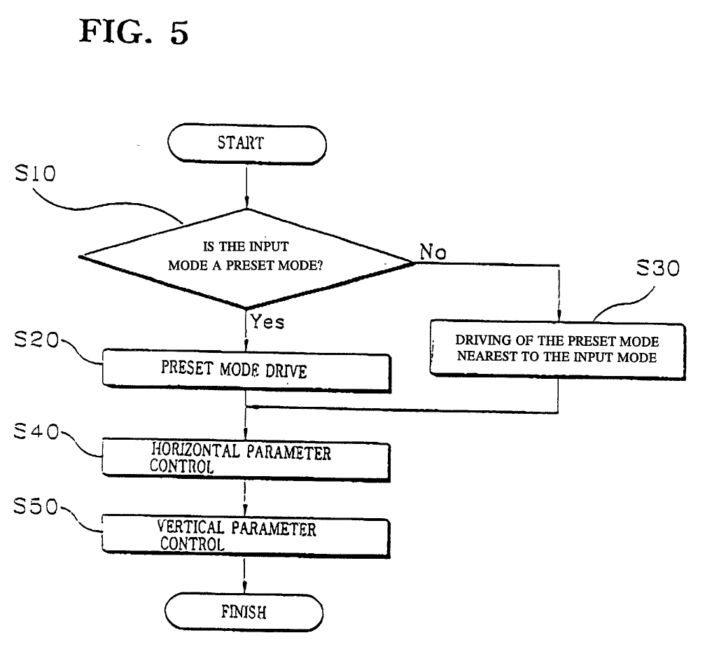

As shown in FIG. 5, a method of automatically controlling images of a flat panel display includes the steps of: checking (S10) whether or not an input mode is preset mode after discriminating a mode of the received horizontal and vertical synchronizing signals; driving (S20) the preset mode in the case that the input mode is the preset mode in the checking step (S10); driving (S30) another preset mode nearest to the input mode in the case that the input mode is not the preset mode in the checking step (S10); controlling (S40) a horizontal parameter according to the input mode when the nearest preset mode is driven in the driving step (S30) after driving the present mode in the driving step (S20); and controlling (S50) a vertical parameter should the horizontal parameter be controlled in the controlling step (S40).

The method described above can be considered more concretely as follows.

It is checked (S10) whether or not an input mode is a preset mode after discriminating a mode of the horizontal and vertical synchronizing signals received by the micro-controller 12. In the case that the input mode is the preset mode, the video signals (R, G, B) received according to the preset mode are displayed (S20). On the contrary, in the case that the input mode is a non-preset mode, another preset mode nearest to the input mode is driven (S30). After the nearest preset mode is driven and the present mode is driven, the horizontal parameter according to the input mode is controlled (S40).

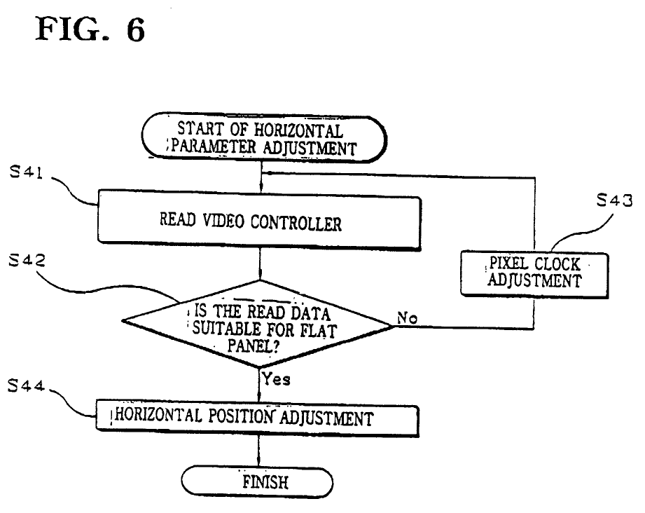

As shown in FIG. 6, the controlling of the horizontal parameter refers to the controlling of the horizontal size and position of the images.

Left and right end registers of the line memory 16a in the video controller 16 are read in the micro-controller 12 (S41). Then it is checked whether or not the first data stored in the left and right end registers are values suitable for the flat panel (S42). When the data are not the suitable values, the pixel clocks (PIXEL_CLK1) and (PIXEL_CLK2) of the first data (R1, G1, B1) are adjusted (S43). On the contrary, when the data are the suitable values, the horizontal positions of the first data (R1, G1, B1) are adjusted (S44).

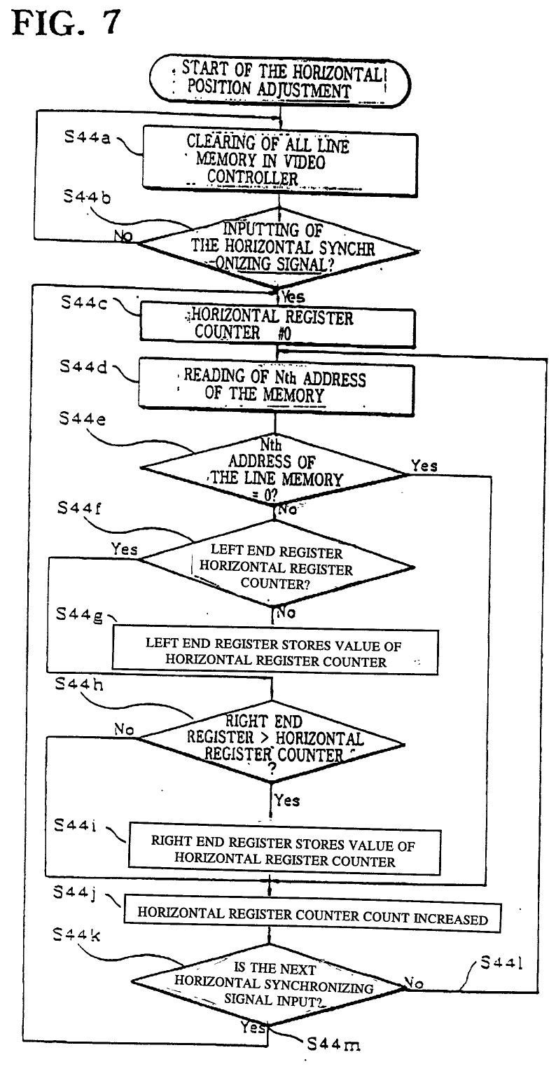

As shown in FIG. 7, the step of adjusting the horizontal position includes adjusting the horizontal size and position of the images of the video signals (R, G, B). First of all, all of the line memory 16a constituted within the video controller 16 are cleared (S44a). When all of the line memory 16a are cleared, it is checked whether or not horizontal synchronizing signal (H_SYNC) is input into the micro-controller 12 (S44b). When the horizontal synchronizing signal (H_SYNC) is input, a horizontal register counter is initialized (S44c). When the horizontal register counter is initialized, the Nth address of line memory 16a is read using the horizontal register counter (S44d). When the Nth address of the line memory 16a is read, the number of the count of the horizontal register counter is refreshed to a minimum/maximum value (S44e, S44f, S44g, S44h, S44i) to distinguish the first data of the offset period from the read data (first data from the active period). In the refreshing step, first, it is checked whether or not first data are stored in the Nth address of the read line memory 16a when the Nth address of the line memory 16a is read (S44e). When the first data are stored in Nth address of the read line memory 16a, the number of the count of the horizontal register counter is refreshed to the minimum value (S44f, S44g). When the first data are stored in the Nth address, it is compared as to whether the address value of the left end register is bigger than the address value counted by the horizontal register counter (S44f). When the address value of the left end register is not bigger than the address value counted by the horizontal register counter, the address value counted by the horizontal register counter is stored in the left end register (S44g).

When the number of the count of the horizontal register counter is refreshed to the minimum value, the number of the count of the horizontal register counter is refreshed to the maximum value once again (S44h, S44i). Therein, it is compared as to whether or not the address value of the right end register is bigger than the address value counted by the horizontal register counter (S44h). When the address value of the right end register is bigger than the value of the address counted by the horizontal register counter, the value of the address counted by the horizontal register counter is stored in the right end register (S44i). As the number of the maximum count of the horizontal register counter is stored in the right end register, the start and end of the display position of the first data (R1, G1, B1) are adjusted.

And when the data are not stored in the Nth address, the number of the count of the horizontal register counter for counting the storing address of the data is increased (S44j) and then it is checked whether or not the next horizontal synchronizing signal (H_SYNC) is input when the horizontal register counter is increased (S44k).

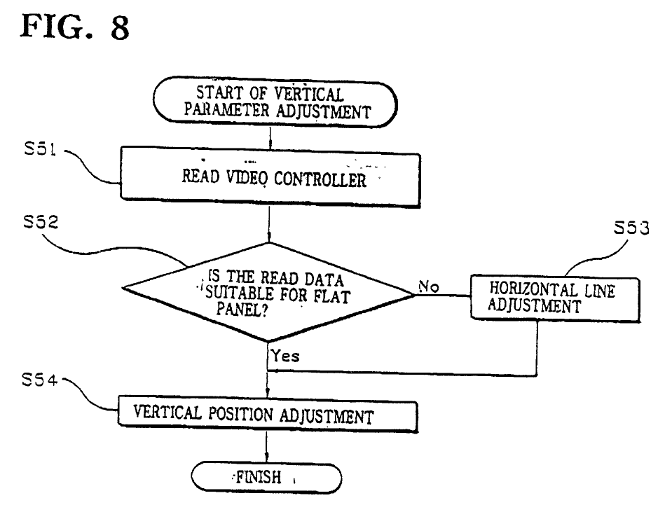

When the controlling of the horizontal parameter is finished, the vertical parameter of the images is controlled (S50) as shown in FIG. 8. Top and bottom end registers of the line memory 16a constituted in the video controller 16a are read in the micro-controller 12 (S51). Then it is checked whether or not the number of the horizontal lines of first data stored in the top and bottom end registers are a value suitable for the flat panel (S52). When the number of the horizontal lines is not the suitable value, the pixel clocks (PIXEL_CLK1, PIXEL_CLK2) of the first data (R1, G1, B1) are adjusted, in order to adjust the number of the horizontal lines (S53), and then the vertical positions of the first data (R1, G1, B1 are adjusted (S54). On the contrary, when the number of the horizontal lines is the suitable value, step S39 is not performed and the process proceeds from step S52 to the Step S54, wherein the vertical positions of the first data (R1, G1, B1) are adjusted (S54).

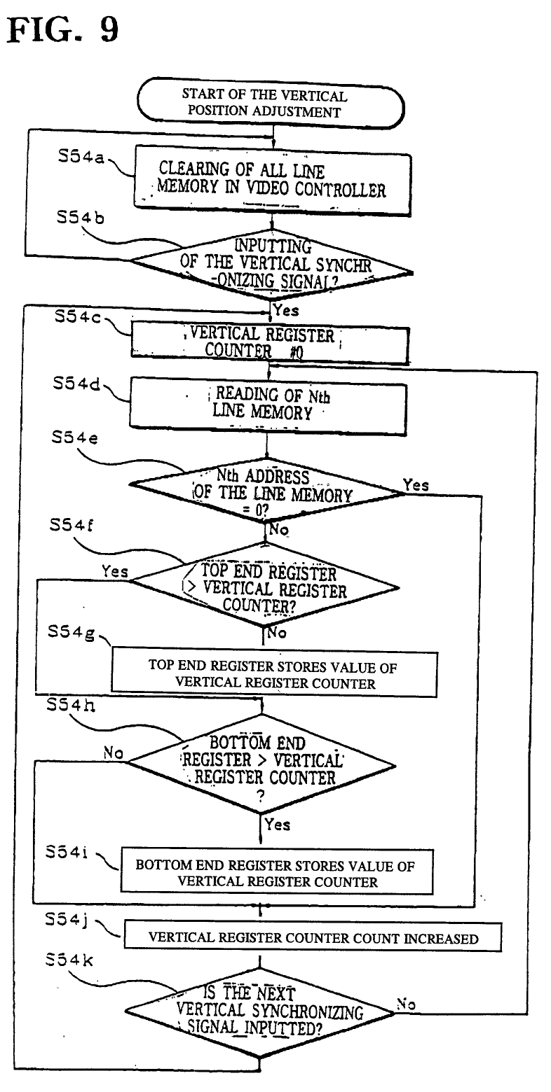

As shown FIG. 9, the step of adjusting the vertical position adjusts the vertical size and position of the images. First of all, all of the line memory 16a constituted within the video controller 16 are cleared (S54a). When all of the line memory 16a is cleared, it is checked whether or not the vertical synchronizing (V_SYNC) signal is input into the micro-controller 12 (S54b). When the vertical synchronizing signals (V_SYNC) is input, a vertical register counter is initialized (S54c). When the vertical register counter is initialized, the Nth address of the line memory 16a is read by the micro-controller 12 (S54d). When the Nth address of the line memory 16a is read, the number of the count of the vertical register IS counter is set to the minimum/maximum value (S54e, S54f, S54g, S54h, S54i).

First, it is checked whether or not first data are stored in Nth address of the read line memory 16a for a period of the horizontal synchronizing signal (H_SYNC) when the Nth address of the line memory 16a is read (S54e). When the first data are stored in the Nth address of the read line memory 16a, the number of the count of the vertical register counter is set to the minimum value (S54f, S54g). When the first data are stored in the Nth address, it is compared as to whether the address value of the top end register is bigger than the address value counted by the vertical register counter (S54f). When the address value of the top end register is not bigger than the address value counted by the vertical register counter, the address value counted by the vertical register counter is stored in the top end register (S54g).

When the number of the count of the vertical register counter is set to the minimum value, the number of the count is set to the maximum value once again. Then, it is compared as to whether or not the value of the address of the bottom end register is bigger than the address value counted by the vertical register counter (S54h). When the value of the address of the top end register is bigger than the value of the address counted by the vertical register counter, the value of the address counted by the vertical register counter is stored in the bottom end register (S54i). When the value of the address counted by the vertical register counter is set to the minimum/maximum value, the number of the count of the vertical register counter is increased (S54j). When the vertical register counter is increased, it is checked whether or not the next vertical synchronizing signal (V_SYNC) is input and the next image frame is adjusted (S54k).

And when the first data are not stored in the Nth address in step S54f, the process skips to step S54j where the number of the count of the vertical register counter for counting the storing address of the data is increased (S54j) and then it is checked whether or not the next vertical synchronizing signal (V_SYNC) is input when the vertical register counter is increased and the vertical position of the images is adjusted (S54k).

As explained above, the present invention can also detect the timing according to modes other than the mode fixed to the flat display panel and can display the best images by automatically controlling a mode, in the case that the mode is unsuitable for the flat panel.

It will be apparent to those skilled in the art that various modifications can be made to the embodiment of the present invention, without departing from the spirit of the invention. Thus, it is intended that the present invention cover such modifications as well as variations thereof, within the scope of the appended claims and their equivalents.

What is claimed is:

1. A device for automatically controlling images represented by video signals of a flat panel display in accordance with synchronizing signals, said device comprising:
a micro-controller to discriminate modes according to the synchronizing signals, and to output an OSD (on screen display) control signal and pixel clock control signals according to the discriminated modes;
a phase-locked loop to control timing of pixel clocks according to the pixel clock control signals of said micro-controller;
an analog to digital converter to receive the video signals, to sample the video signals according to one of the pixel clocks from said phase-locked loop, and to convert the sampled video signals into digital video signals; and
a video controller to receive the digital video signals transmitted from said analog-digital converter, to output the digital video signals according to the pixel clocks from the phase-locked loop and the OSD control signal from the micro-controller; and
a panel driver to transfer the digital video received from the video controller to the flat panel display.

2. The device as claimed in claim 1, further comprising an OSDIC (on screen display integrated circuit) to receive the OSD control signals provided from said micro-controller, to generate OSD data to display the images according to image adjustment, and to output the OSD data to said video controller.

3. The device as claimed in claim 1, wherein said analog to digital converter adjusts sizes of the images of the video based upon the sampling of the video signals, wherein the sampling of the video signals is based upon the discriminated modes determined by said micro-controller.

4. The device as claimed in claim 1, further comprising a switching mode power supply which transmits power to the panel driver, to amplify the digital video signals output from the panel driver to a minimum level.

5. The device as claimed in claim 1, wherein said video controller comprises a line memory having columns and rows, to store the digital video signals in a received order according to the pixel clocks;
wherein a size of an amount of data of the digital video signals stored at addresses of the columns is adjusted by repeatedly adding or deleting to a frequency of the one pixel clock which is input to the analog to digital converter during the sampling of the video signals.

6. The device as claimed in claim 5, wherein if the flat panel display has a resolution greater than the video signals of the input mode, the frequency of the one pixel clock is added to, and if the flat panel display has a resolution less than the video signals of the input mode, the frequency of the one pixel clock is deleted from.

7. A device for automatically controlling images represented by video signals of a flat panel display in accordance with horizontal and vertical synchronizing signals, comprising:
a processing unit to determine an input mode of the video signals from the horizontal and vertical synchronizing signals, determine whether the input mode is suitable for the flat panel display, maintaining the input mode of the video signals if the input mode is suitable for the flat panel display and changing the input mode to a first preset mode if the input mode is not suitable for the flat panel display; and
a driver to display the input mode or the preset mode video signals on the flat panel display.

8. The device as claimed in claim 7, wherein the first preset mode is one of a plurality of preset modes closest to the input mode.

9. The device as claimed in claim 7, wherein said processing unit determines whether the input mode is suitable for the flat panel display by determining if the input mode is a second preset mode.

10. The device as claimed in claim 8, wherein said processing unit determines whether the input mode is suitable for the flat panel display by determining if the input mode is a second one of the plurality of preset modes.

11. A method of automatically controlling images represented by video signals of a flat panel display in accordance with horizontal and vertical synchronizing signals, said method comprising the steps of:
checking whether an input mode is a first preset mode after discriminating the input mode according to the horizontal and vertical synchronizing signals;
driving a second preset mode nearest to the input mode in case the input mode is not the first preset mode;
controlling a horizontal parameter of the video signals according to the input mode in response to the second preset mode being driven in said driving step; and
controlling a vertical parameter of the video signals in response to the horizontal parameter being controlled.

12. The method as claimed in claim 11, wherein the checking step includes a step of driving the first preset mode in response to the input mode being checked to be the first preset mode.

13. The method as claimed in claim 11, wherein the step of controlling the horizontal parameter includes the steps of:
reading a left end register and a right end register in which first data of the video signals are stored and formed in a video controller;
checking whether the first data stored in the left end register and the right end register read in said reading step are values suitable for the flat panel display;
adjusting a pixel clock of the first data in response to the first data not being the suitable values; and
adjusting a horizontal position of the first data in response to the first data being the suitable values.

14. The method as claimed in claim 13, wherein the step of adjusting said horizontal position includes the steps of:
clearing all of a line memory formed within the video controller;
checking whether the horizontal synchronizing signal is input into a micro-controller in response to all of the line memory being cleared;
initializing a horizontal register counter in response to the horizontal synchronizing signal being input;
reading an Nth address of the line memory using the horizontal register counter in response to the horizontal register counter being initialized;
refreshing a number of a count of the horizontal register counter to a minimum/maximum value to distinguish the first data of an offset period of the video signals from the read first data at the Nth address of the line memory;
increasing the number of the count of the horizontal register counter to count the address, where the first data are stored, in response to the number of the count of the horizontal register counter being refreshed to the minimum/maximum value; and
checking whether a next horizontal synchronizing signal is input in response to the horizontal register counter being increased.

15. The method as claimed in claim 14, wherein said refreshing step includes the steps of:
checking whether the first data are stored in the Nth address of the line memory in response to the Nth address of the line memory being read;
refreshing the number of the count of the horizontal register counter to the minimum value in response to the first data being stored in the Nth address of read line memory; and
refreshing the number of the count of the horizontal register counter to the maximum value in response to the number of the count of the horizontal register counter being refreshed to the minimum value.

16. The method as claimed in claim 15, wherein the step of refreshing the number of the count to the minimum value includes the steps of:
comparing whether an address value of the left end register is bigger than an address value counted by the horizontal register counter in response to the first data being stored in the Nth address; and
storing the address value counted by the horizontal register counter in the left end register in response to the address value of the left end register not being bigger than the address value counted by the horizontal register counter.

17. The method as claimed in claim 16, wherein the step of refreshing the number of the count of the horizontal register counter comprises the steps of:
comparing whether an address value of the right end register is bigger than an address value counted by the horizontal register counter in response to the address value of the left end register being bigger than the address value counted by the horizontal register counter; and
storing the address value counted by the horizontal register counter in the right end register in response to the address value of the right end register being bigger than the address value counted by the horizontal register counter.

18. The method as claimed in claim 11, wherein said step of controlling the vertical parameter includes the steps of:
reading a top end register and a bottom end register in which first data of the video signals are stored are formed in a video controller;
checking whether the number of the count of horizontal lines of the first data stored in the top end register and the bottom end register are a value suitable for the flat panel display;
adjusting a pixel clock for adjusting a number of a count of the horizontal lines of the first data in response to the number of the count of the horizontal lines not being the suitable value; and
adjusting a vertical position of the first data by adjusting the horizontal lines in response to the first data being the suitable value.

19. The method as claimed in claim 18, wherein said step for adjusting the vertical position includes the steps of:
clearing all of a line memory formed within the video controller;
inputting the vertical synchronizing signal to a micro-controller;
initializing a vertical register counter according to the inputting of the vertical synchronizing signal to the micro-controller;
reading an Nth address of a line memory using the initialized vertical register counter;
setting the number of the count of the vertical register counter in the read Nth address of the line memory to a minimum/maximum value;
increasing the number of the count of the vertical register counter for counting the address in which first data are stored in response to the number of the count of the vertical register counter being set to the minimum/maximum value; and
checking whether a next vertical synchronizing signal is input in response to the number of the count being increased.

20. The method as claimed in claim 19, wherein said setting step includes the steps of:
checking whether first data are stored for a period of the horizontal synchronizing signal in the read Nth address of the line memory in response to the Nth address of the line memory being read;
setting the number of the count of the vertical register counter to the minimum value in response to determining that the first data are stored in the Nth address of the line memory; and
setting the number of the count of the vertical register counter to the maximum value in response to the number of the count of the vertical register counter being set to the minimum value.

21. The method as claimed in claim 20, wherein the step of setting the number of the count of the vertical register counter to the minimum value includes the steps of:
comparing an address value of the top end register with the address value of the line memory counted by the vertical register counter in response to determining that the data are stored in the Nth address of the line memory; and
storing the address counted by the vertical register counter in the top end register in response to the address value of the top end register not being bigger than the address value of the line memory counted by the vertical register counter.

22. The method as claimed in claim 20, wherein the step for setting the number of the count of the vertical register counter to the maximum value includes the steps of:
comparing an address value of the bottom end register with the address value counted by the vertical register counter in response to the address value of the top end register being bigger than the address value counted by the vertical register counter; and
storing the address value counted by the vertical register counter in the bottom end register in response to the address of the top end register being bigger than the address value counted by the vertical register counter.

23. A method of automatically controlling images represented by video signals of a flat panel display in accordance with horizontal and vertical synchronizing signals, the method comprising the steps of:
determining an input mode of the video signals from the horizontal and vertical synchronizing signals;
determining whether the input mode is suitable for the flat panel display;
maintaining the input mode of the video signals if the input mode is suitable for the flat panel display and changing the input mode to a first preset mode if the input mode is not suitable for the flat panel display; and
displaying the input mode or the first preset mode video signals.

24. The method as claimed in claim 23, wherein the step of determining whether the input mode is suitable for the flat panel display comprises the steps of:
determining whether the input mode is a second preset mode; and
determining that the input mode suitable for the flat panel display if the input mode is the second preset mode.
